(19) United States
(12) Patent Application Publication
(10) Pub. No.: US 2004/0044538 A1
(43) Pub. Date: Mar. 4, 2004

(54) System and method for processing applications for employment

(76) Inventors: Katherine G. Mauzy, St. Louis, MO (US); Andrew Dingle, Montclair, NJ (US)

Correspondence Address: Leslie Gladstone Restaino, Esq., Brown Raysman Millstein Felder & Steiner LLP, 163 Madison Avenue, P.O. Box 1989, Morristown, NJ, 07962-1989, US

(21) Appl. No.: 10/229,991

(22) Filed: Aug. 27, 2002

(51) Int. Cl. G06F 17/60

(52) U.S. Cl. 705/1

(57) ABSTRACT

A method for processing applications for employment from candidates involves receiving one or more sets of data each of which identifies a candidate and represents the candidate's employment application. Each received set of data is stored in a database. One or more initial hiring decisions are received and stored, each of which corresponds to a set of data stored in the database. Each set of data having a favorable initial hiring decision is automatically transmitted, upon receipt of the favorable initial hiring decision, to one or more screening officers to enable them to cause one or more screening procedures to be performed on the employment candidate identified in the respective set of data. One or more screening procedure results are received from the one or more screening officers and stored. A report is provided of each employment candidate for which favorable initial hiring decisions and screening procedure results are stored.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention disclosed herein relates generally to computer networks for receiving and processing data. More particularly, the present invention relates to a system and method for using a computer network to receive and process data related to applications for employment.

### BACKGROUND OF THE INVENTION

Employers often use methods for receiving employment application data from potential new employees that are highly manually intensive. For example, potential new employees, or employment candidates, may fill out paper applications for employment in any number of branch locations a company may have nationwide. The paper applications may be faxed to a processing center where a fax server stores the received application as digital image files. An OCR application converts the digital images to text files and operators manually correct any errors from the OCR process. Then, at the end of each day, a batch process may send the text files of all applicants received that day to a database at a central mainframe computer.

Such a process for receiving applications is inefficient since staff must be used to verify and correct data not properly recognized in the OCR process. As the number of applications the company receives increases, the number of staff needed to verify and correct the applications increases. In addition, there is often insufficient supervision of employment candidates when they fill out the applications and consequently, the applications forms may not be filled out properly or completely.

Also, once application data has been received, employers often use inefficient methods for screening applications. For example, a branch manager responsible for hiring hew employees may access the mainframe database to view data related to applications and provide approval codes for those applications of which the manager approves. Then, periodically, e.g., twice a day, a batch process may print out the applications that have received initial approval and those printed applications are sent to screening departments so that further screening, such as background checks, may be performed on the applicant. The status of the further screening, e.g., approval, disapproval, or pending, is periodically provided to the mainframe database. To determine the status of applications the branch manager has initially approved and sent on for further screening, the branch manager must periodically access the mainframe database review the status accorded to the various applications stored there.

This screening process has several disadvantages. First, where an employment candidate has entered incorrect or incomplete information, the candidate often must be contacted again to obtain the proper information before the further screening can be continued. Also, there is a time lag that slows down the screening process from the time the branch manager initially approves of a candidate and the time the screening departments receive an application from the branch process.

Therefore, there is a need for a system and method for receiving and screening applications for employment that can more efficiently receive application data to thereby reduce or eliminate staff requirements and that can reduce the occurrences of candidates entering incorrect or incomplete application data. Also, a system and method is needed to reduce the time lag between the time an application receives initial approval and the time the application is forwarded to screening departments for further screening.

### BRIEF SUMMARY OF THE INVENTION

The disadvantages above are overcome by a system and method for processing applications for employment described herein. The method involves receiving one or more sets of data, wherein each set of data identifies an employment candidate and represents an application for employment from the identified employment candidate. Each received set of data is stored in a database. One or more initial hiring decisions are received, wherein each initial hiring decision corresponds to a set of data stored in the database. Each set of data for which a favorable initial hiring decision is received is transmitted from the database to one or more screening officers to enable further screening procedures to be performed on the employment candidate identified in the respective set of data, wherein each respective set of data is transmitted automatically upon receiving the corresponding favorable initial hiring decision.

The method may also involve storing each received initial hiring decision in the database in association with the set of data to which the respective received initial hiring decision corresponds. One or more screening procedure results may be received from the one or more screening officers, wherein each of the one or more screening procedure results corresponds to a set of data stored in the database having a favorable initial hiring decision stored in association with it, and wherein each of the one or more screening procedure results corresponds to one of the one or more screening procedures. Each of the received one or more screening procedure results may be stored in the database in association with the set of data to which the respective received screening procedure result corresponds.

The method also provides reports listing employment candidates that have received favorable initial hiring decisions and favorable screening procedure results. The database is searched for each set of data wherein the initial hiring decision stored in association with the respective set of data is favorable, and wherein each screening procedure result stored in association with the respective set of data is favorable. Therefore, an employment decision-maker is informed of the identity of each employment candidate identified in each set of data found in the search.

Users, including employment candidates, employment decision-makers, and screening officers, operate User Interface Devices to communicate and interact with an Online Application System through a network. The Online Application System interacts with users via the User Interface Devices to receive data from and present data to the users, including sets of data from employment candidates representing applications for employment, initial hiring decisions from decision-makers, and screening procedure results from screening officers. An Applicant Tracking Database stores the sets of data from employment candidates representing applications for employment, initial hiring decisions from decision-makers, and screening procedure results from screening officers.

In an embodiment of the present invention, the Online Application System presents one or more interface screens to employment candidates via User Interface Devices. Each employment candidate interacts with the interface screens to provide a set of data representing the candidate's application for employment. These sets of data are transmitted from the User Interface Devices operated by the employment candidates over the network and received by the Online Application System. The Online Application System stores the received sets of data in the Applicant Tracking Database.

The Online Application System presents one or more sets of data stored in the Applicant Tracking Database to an employment decision-maker, such as, for example, in response to a query from the employment decision-maker. The employment decision-maker reviews the one ore more sets of data presented and provides an initial hiring decision corresponding to one or more of the presented sets of data. The Online Application System receives these initial hiring decisions and stores them in the Application Tracking Database in association with the sets of data to which they correspond. Upon receiving the initial hiring decisions, the Online Application System automatically analyzes them to identify each favorable initial hiring decision and then transmits each set of data for which a favorable initial hiring decision was received to screening officers to enable them to cause one or more screening procedures to be performed on the employment candidates identified by those sets of data.

The screening officers cause screening procedures (e.g., background and credit checks) to be performed on the employment candidates identified by each set of data for which a favorable initial hiring decision was received and the results of those screening procedures are sent back to and received by the Online Application System. The Online Application System then stores the received screening procedures in the Applicant Tracking Database in association with the sets of data to which they correspond.

The Online Application System may, at given times such as once a day, provide reports of employment candidates. For example, the Online Application System may search the Applicant Tracking Database for all sets of data identifying employment candidates who have received favorable initial hiring decisions and favorable screening procedure results. A report listing each such candidate and providing the set of data for the candidate may then be transmitted to one or more employment decision-makers or other members of the organization.

Any member of the organization with proper authorization may use a User Interface Device to communicate with the Online Application System to obtain the application status of one or more employment candidates. The Online Application System may then return to the inquiring member a report showing the initial hiring decision and screening procedure results stored for the one or more employment candidates.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram showing an embodiment of the system of the present invention and the environment in which it operates;

FIG. 2 is a block diagram showing a data structure used in an embodiment of the system of the present invention; and

FIGS. 3A and 3B are a flow chart showing an operative embodiment of the present invention.

### DETAILED DESCRIPTION OF THE PREFERRED EMBODIMENTS

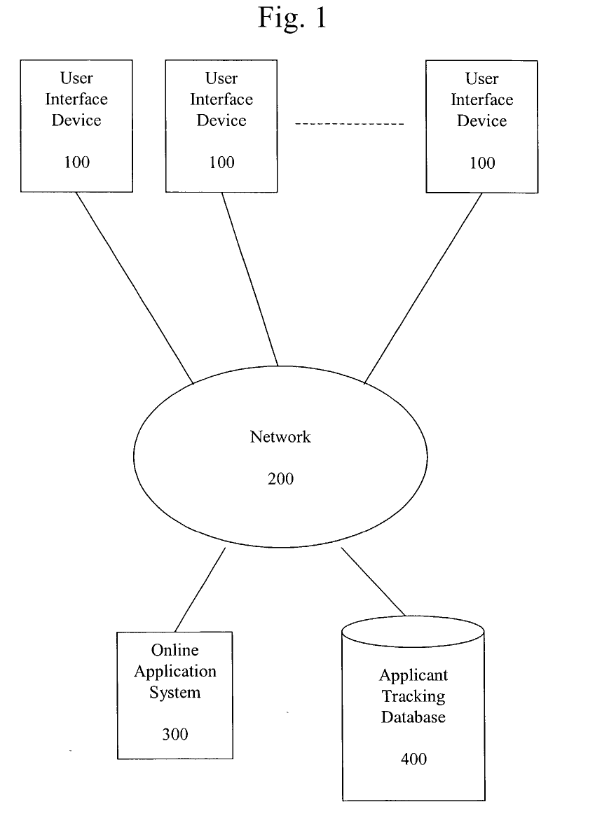

The preferred embodiments of a method, system, and article of manufacture containing software programs in accordance with the present invention is described with reference to the drawings in FIGS. 1-3B.

FIG. 1 is a block diagram showing the structure and operating environment of an embodiment of the present invention. An organization, seeking to receive applications for employment from employment candidates and process those applications, employs an Online Application (“OA”) System 300. Users operate user interface (“UI”) devices 100 in order to communicate and interact with the OA System 300 through a network 200. The OA System 300 also communicates through network 200 with an Applicant Tracking (“AT”) Database 400.

Users include all individuals interacting with the OA System 300, such as, for example, employment candidates seeking employment with the organization, employment decision-makers (e.g., managers within the organization responsible for hiring new employees), and screening officers (e.g., administrators within the organization responsible for screening employment candidates). Users operate UI Devices 100 that may comprise any computer hardware and software that allows them to exchange data and interact with OA System 300 over network 200. For example, UI Device 100 may comprise a personal computer or other computer workstation with communications software that will enable communications over network 200 with OA System 300. For instance, where network 200 is the Internet or an intranet and OA System 300 includes software enabling it to function as a web server, then UI Devices 10 may use standard web browser software to communicate over network 200 with OA System 300.

Network 200 may comprise any type of communications network through which computers may communicate. For example, network 200 may comprise a LAN, WAN, the Internet or an internal intranet. Furthermore, although FIG. 1 shows network 200 as a single network, it should be understood that network 200 may comprise a plurality of the networks previously described, all of which form a communications path linking UI Devices 100, OA System 300, and AT Database 400.

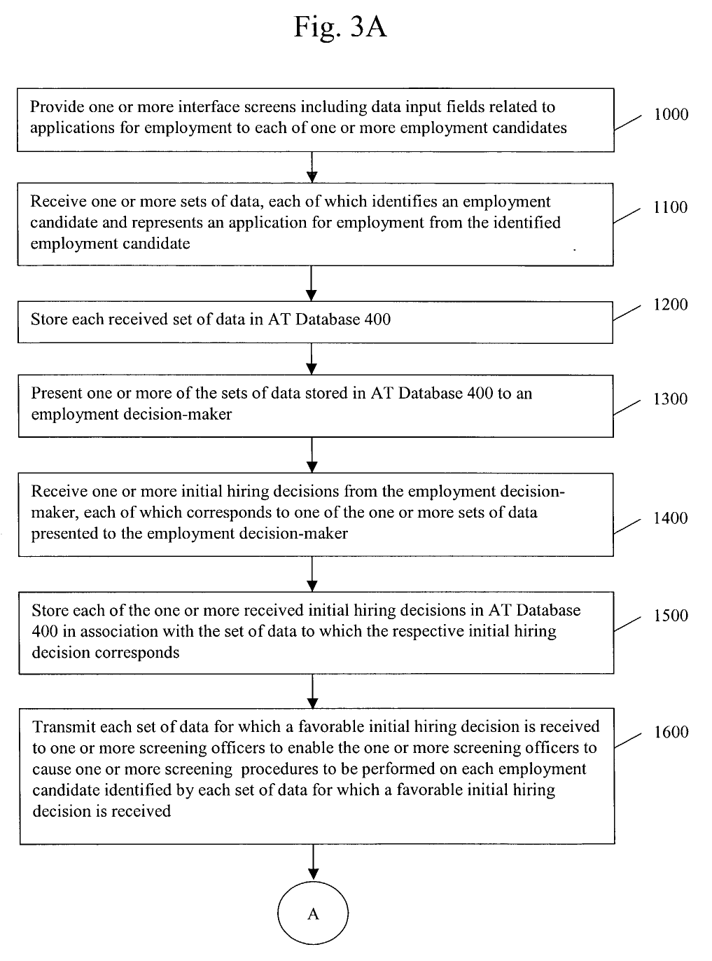

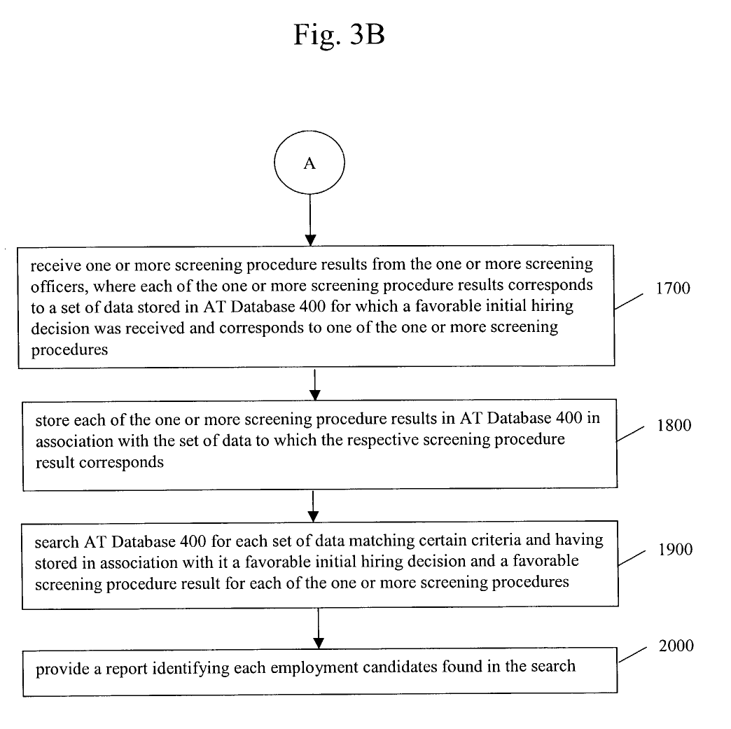

OA System 300 may be any computer system (a) that is capable of communicating with UI Devices 100 over network 200, (b) that is capable of communicating with AT Database 400 over network 200, and (c) that is capable of operating according to the logic described below in accordance with FIGS. 3A-3B. For example, OA System 300 may comprise a computer server with computer code modules allowing it to communicate over network 200 with UI Devices 100 and AT Database 400 and computer code modules allowing it to execute the logic described below in accordance with FIGS. 3A-3B.

AT Database 400 may comprise any computer system capable of receiving and storing data and providing access to this stored data to other computer systems. For example, AT Database 400 may provide data access to other computer systems via responses to search queries from those other systems.

AT Database 400 stores at least two types of information: (a) data from employment candidates representing applications for employment; and (b) data from employment decision-makers and screening officers representing initial hiring decisions and screening decisions, respectively, made with regard to each application.

The data representing applications for employment includes a set of data corresponding to each employment candidate representing that candidate's application for employment. For example, a set of data may identify the employment candidate to which the set of data corresponds by any appropriate means of identification such as, for example, by name, by social security number, or any other unique identifier, e.g., an application number. Also, a set of data may include information from the employment candidate to which the set of data corresponds that would normally be provided in response to a conventional application for employment, such as, for example, the employment candidate's work history, educational background, references, or permission to conduct background and credit checks on the candidate.

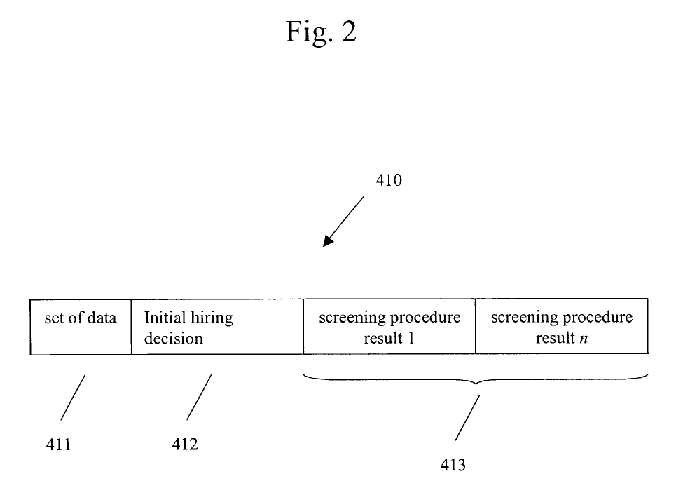

The sets of data may be stored in AT Database 400 in any manner conventionally used with databases. For example, each set of data corresponding to a particular employment candidate may be stored in a separate database record 410 as shown in FIG. 2, with the set of data being stored in a portion of the record 411.

Data stored in AT Database 400 from employment decision-makers and screening officers represents hiring approval and screening approval decisions, respectively, made with regard to applications for which corresponding sets of data are stored in AT Database 400.

Employment decision-makers, such as, for example, managers or any other members of the organization responsible for hiring new employees, may review sets of data from AT Database 400 representing applications from employment candidates and provide an initial hiring decision with regard to those applications. Such initial hiring decisions may be provided to AT Database 400 as codes indicating, for example, approval of an application, disapproval of an application, or that an initial hiring decision on the application is still pending.

Data from employment decision-makers representing initial hiring decisions corresponding to particular sets of data may be stored in AT Database 400 in any manner so long as they are stored in association with the sets of data to which they correspond. For example, where, as shown in FIG. 2, each set of data representing an application for employment from a particular employment candidate is stored in a separate database record 410, the initial hiring decision corresponding to the respective set of data may be stored in a designated field of the record, e.g. initial hiring decision field 412.

Screening officers may include members of the organization responsible for causing screening procedures to be performed on employment candidates and for reporting the results of those procedures. Screening officers of the organization may receive sets of data representing applications from employment candidates, cause screening procedures to be performed on those employment candidates, and then the results of the screening procedures. Screening procedures performed on employment candidates may include, for example, background checks (e.g., checks on criminal history and references) and credit checks (e.g., checks on credit history). Such screening procedure results may be provided to AT Database 400 as codes indicating, for example, approval of an application, disapproval of an application, or that results to the screening procedure for the application are still pending.

Data from screening officers representing screening procedure results corresponding to particular sets of data may be stored in AT Database 400 in any manner so long as the data is stored in association with the set of data to which the screening procedure result corresponds. For example, where, as shown in FIG. 2, each set of data representing an application for employment from a particular employment candidate is stored in a separate database record 410, the screening procedure results corresponding to the respective set of data may be stored in designated fields of the record. For example, each record 410 may have one or more screening procedure result fields 413 in which screening procedure results may be stored, with each field 413 storing the result for a different type of screening procedure. For example, where the organization causes two types of screening procedures to be performed on employment candidates, e.g., background checks and credit checks, each record 410 may include two screening procedure result fields 413 with one field 413 storing results for background checks and the other field 413 storing results for credit checks.

Computer system here is used broadly to mean computer hardware and software or computer software only. For example, in FIG. 1, OA System 300 is shown as distinct from AT Database 400. However, it should be understood that OA System 300 and AT Database 400 may be co-resident on the same computer hardware. In addition, it should be understood that although OA System 300 and AT Database 400 are shown as singular systems, each may comprise multiple computer hardware and software systems in communication with each other such that, as a group, they perform the functions of OA System 300 or AT Database 400, respectively.

The general operation of an embodiment of the present invention may now be described with reference to the flowchart of FIGS. 3A and 3B. First, as shown in FIG. 3A, one or more interface screens including data input fields related to an application for employment are provided to each of one or more employment candidates, step 1000. For example, one or more employment candidates wishing to apply for employment with the organization may enter an office location of the organization and fill out an online employment application via an UI Device 100. Interface screens, as described above, comprising graphics or text may be sent from OA System 300 over network 200 to UI Device 100 for presentation and interaction with the employment candidate. It should be noted that a large organization may have branch offices at geographically dispersed locations with one or more UI Devices 100 at each such location through which employment candidates may fill out such online employment applications.

Each employment candidate may interact with the interface screens by providing data to the data input fields. The data an employment candidate provides to these fields comprises a set of data that represents the candidate's application for employment. The information requested in the data input fields, and thus provided by an employment candidate, may be similar to the type of information normally requested by conventional applications for employment, such as, for example, identification information (e.g., name, age, address, social security number), work history, educational background, and references. Also, the candidate may be requested to give permission for the organization to perform further screening procedures on the candidate, e.g., background and credit checks.

If desired, the one or more interface screens provided in step 1000 may include one or more mandatory data input fields. OA System 300 may force the employment candidate to fill in such mandatory fields, by, for example, verifying that those fields have been filled in and not left blank and have been filled in with the correct format of data (e.g., number or text). Where mandatory fields have not been filled in or have not been filled in correctly, OA System 300 may present the one or more interface screens to the employment candidate again and display a message instructing the candidate to properly fill in those fields.

Returning to FIG. 3A, after the one or more interface screens are presented to each of the one or more employment candidates, OA System 300 receives one or more sets of data, each of which identifies an employment candidate and represents an application for employment from the identified employment candidate, step 1100. For example, each set of data provided by each of the one or more employment candidates may be transmitted from the UI Device 100 operated by the respective candidate over network 200 where it is received by OA System 300. If desired, OA System 300 may assign an additional unique identifier, e.g., a sequentially or randomly generated application number, to each set of data received.

Next, each set of data received by OA System 300 is stored at AT Database 400, step 1200. For example, OA System 300 may send each set of data it receives to AT Database 400 where each east set of data is stored in any manner conventionally used with databases. For example, AT Database 400 may store each received set of data in a separate database record.

Steps 1000, 1100, and 1200 of FIG. 3A may be repeated continually over time such that sets of data representing applications for employment from employment candidates may be continually received by OA System 300 and stored in AT Database 400. Then, at any point after at least one set of data has been stored in AT Database 400, employment decision-makers may review stored sets of data and provide initial hiring decisions with regard to the corresponding employment candidates.

As shown in FIG. 3A, review of sets of data representing applications for employment begins at step 1300, where one or more sets of data stored in AT Database 400 are presented to an employment decision-maker. For example, an employment decision-maker at a given office location may use a UI Device 100 at that location to communicate with OA System 300 to request to review applications for employment that have been received by the organization. In response to the request, OA System 300 may retrieve one or more sets of data from AT Database 400 and transmit those retrieved sets of data over network 200 to the UI Device 100 for presentation to the employment-decision maker.

A request to review applications for employment may take a variety of forms. For example, the employment decision-maker may request to review applications matching particular employment candidates by providing identification information for those candidates, e.g., name, social security number, or application number. Alternatively, the employment decision-maker may request to review all applications matching certain criteria, e.g., all applications received from a given office location on a particular date or all applications received showing candidates with particular characteristics, such as, for example, education level, years of experience, or graduation from a particular institution.

Upon receiving a request to review applications from a particular UI Device 400, OA System 300 may send a query to AT Database 400 to retrieve all sets of data matching the parameters of the request. OA System 300 may then send the set(s) of data, if any, retrieved from AT Database 400 to the UI Device 100 that sent the request so that they may be presented to the employment decision-maker.

The retrieved set(s) of data may be presented to the employment decision-maker using any of a number of known user interface methods. For example, the retrieved set(s) of data may be represented initially in a list where only identifying information from each set of data (e.g., the name of the employment candidate to which the set of data corresponds) appears in the list. Adjacent to each list item may be some means for the employment decision-maker to provide an initial hiring decision, e.g., approved, disapproved, or pending. If desired, the status of each set of data may have an initial default setting, e.g., pending, with the employment decision-maker needing to take affirmative action to change the default status, e.g., from pending to approved or disapproved. Also, some means may be provided through which the employment decision-maker may obtain detailed information concerning each employment candidate. For example, each item presented in the list may be linked (e.g., as hyperlink text) to its corresponding set of data such that upon selecting an item in the list (e.g., clicking on an employment candidate name), the rest of the data in the corresponding set of data is presented to the employment decision-maker (e.g., in one or more screens or pages of data).

Returning to FIG. 3A, after the one or more sets of data have been presented, one or more initial hiring decisions are received from the employment decision-maker, with each of the received initial hiring conditions corresponding to one of the presented sets of data, step 1400. For example, as described above, the retrieved set(s) of data may be presented to the employment decision-maker as items in a list with a means to provide an initial hiring decision (e.g., three buttons labeled “approved”, “disapproved”, and “pending”) adjacent to each item. The employment decision-maker may then use these means to provide initial hiring decisions for one or more presented sets of data. Following the example above, the employment decision-maker may push an “approved”, “disapproved”, or “pending” button corresponding to each of one or more of the sets of data presented in the list. The UI Device 100 being operated by the employment decision-maker may then transmit each initial hiring decision provided by the employment decision-maker over network 200 so that they are received by OA System 300. Along with each initial hiring decision, an identifier to the set of data to which the respective initial hiring decision corresponds may also be transmitted by the UI Device 100 and received at OA System 300. Such an identifier may be, for example, identification information (e.g., name or social security number of the employment candidate) from the set of data.

At any time after OA System 300 receives the one or more initial hiring decisions and the corresponding data set identifiers, each of these one or more initial hiring decisions may be stored in AT Database 400 in association with the set of data to which the respective initial hiring decision corresponds, step 1500. For example, where, as shown in FIG. 2, each set of data is stored in a separate record 410, OA System 300 may send the one or more initial hiring decisions and the corresponding data set identifiers to AT Database 400 which then stores each of the one or more initial hiring decisions in the field 412 of the record 410 containing the set of data in field 411 that matches the data set identifier corresponding to the respective initial hiring decision.

In addition to causing the one or more initial hiring decisions to be stored in AT Database 400, upon receiving the one or more initial hiring decisions, OA System 300 automatically transmits each set of data for which a favorable initial hiring decision is received to one or more screening officers to enable the one or more screening officers to cause one or more screening procedures to be performed on each employment candidate identified by each set of data for which a favorable initial hiring decision is received, step 1600. OA System 300 performs this transmission automatically upon the one or more initial hiring decisions being received, e.g., without any human intervention or substantial delay.

Upon receiving the one or more initial hiring decisions and the corresponding data set identifiers, OA System 300 may accomplish step 1600 by, for example, first analyzing the received one or more initial hiring decisions to identify those that are favorable, e.g., indicate “approved”. Then, using the received data set identifiers corresponding with each favorable initial hiring decision, OA System 300 may obtain each set of data corresponding to each favorable initial hiring decision. For example, OA System 300 may send a query specifying the data set identifiers corresponding with each favorable initial hiring decision to AT Database 400 to retrieve the sets of data stored therein matching those data set identifiers.

Once each set of data having a favorable initial hiring decision is obtained, OA System 300 may transmit each such set of data to the one or more screening officers by, for example, sending an electronic message, e.g., e-mail, containing each such set of data to the UI Devices 100 being operated by each of the one or more screening officers. The number of screening officers to whom these sets of data are transmitted depends upon how many screening procedures are to be performed on employment candidates and how many screening officers are responsible within the organization for those screening procedures. In an embodiment of the invention, two types of screening procedures are performed; background checks (including criminal history checks) and credit checks, and different screening officers are responsible for each type of screening procedure. Specifically, a compliance officer is responsible for background checks and an asset protection and recovery (“APR”) officer is responsible for credit checks. Thus, in this embodiment, OA System 300 may transmit each set of data for which a favorable initial hiring decision was received to two screening officers, a compliance officer and an APR officer, who then cause two screening procedures, background and credit checks, respectively, to be performed on the employment candidates identified by each respective set of data.

It should be noted, however, that a single screening officer may be responsible for all screening procedures. In such a situation, OA System 300 would transmit each set of data for which a favorable initial hiring decision was received to only one screening officer.

After the one or more screening officers (e.g., compliance and APR officers) receive the one or more sets of data having favorable initial hiring decisions, they cause one or more screening procedures (e.g., background checks and credit checks) to be performed on the employment candidates identified by these sets of data. This may be accomplished in any known manner. For example, the screening officers may contact third parties that specialize in performing such screening procedures.

The next step in the operation of the invention is shown in FIG. 3B where OA System 300 receives one or more screening procedure results from the one or more screening officers, where each of the one or more screening procedure results corresponds to a set of data stored in AT Database 400 for which a favorable initial hiring decision was received and also corresponds to one of the one or more screening procedures, step 1700. For example, at any time after which the one or more screening officers have caused the one or more screening procedures to be performed on employment candidates identified by sets of data for which favorable initial hiring decisions were received, the one or more screening officers may receive data related screening procedures results, where the data identifies one or more employment candidates and provides the result of the screening procedure performed on each candidate. For example, in an embodiment of the invention where background and credit checks are performed on each candidate for which a favorable initial hiring decision was received and a compliance officer and an APR officer are responsible for the background and credit checks, respectively, the compliance officer may receive a report identifying one or more employment candidates and providing the results of the background check performed on each candidate identified therein and the APR officer may receive a report identifying one or more employment candidates and providing the results of the credit check performed on each candidate identified therein.

Upon receiving these results, a screening officer (e.g., a compliance or APR officer) may utilize an UI Device 100 to communicate with OA System 300 to indicate that screening procedure results are to be provided. OA System 300 may send one or more interface screens to the UI Device 100 for presentation to the screening officer that allow the screening officer to (a) indicate the type of screening procedure for which results are being entered (e.g., background or credit check), (b) identify one or more employment candidates (e.g., by name or social security number), and (c) provide a screening procedure result (e.g., approved, disapproved, or pending) for each of the identified employment candidates. The data provided by the screening officer is then transmitted by the UI Device 100 over network 200 where it is received by OA System 300.

Returning to FIG. 3B, after the one or more screening procedure results are received, each of them are stored in AT Database 400 in association with the set of data to which the respective screening procedure result corresponds, step 1800. For example, from the data received from the one or more screening officers, OA System 300 may send to AT Database 400 each screening procedure result (e.g., approved, disapproved, or pending) that OA System 300 received, as well as the type of screening procedure performed (e.g., background or credit check) and data identifying the employment candidate (e.g., name or social security number) corresponding to the respective screening procedure result. Where each set of data is stored in a separate database record as shown in FIG. 2, AT Database 400 then may use the data identifying the employment candidate to find the record 410 containing a set of data 411 that identifies the same candidate. Once the record is found, AT Database 400 may then store screening procedure result in the record in the field 413 matching the type of screening procedure performed. For example, where background and credit checks are stored in the first and second screening procedure result fields 413, respectively, and the screening procedure result received was for a background check, AT Database 400 would store this screening procedure result in the first screening procedure result field 413 of the found record.

It should be understood that steps 1300 to 1800 of FIGS. 3A and 3B may be repeated continually over time such that initial hiring decisions and screening procedure results may be continually received by OA System 300 and stored in AT Database 400.

Returning to FIG. 3B, OA System 300 may search AT Database 400 for each set of data matching certain criteria and having stored in association with it a favorable initial hiring decision and a favorable screening procedure result for each of the one or more screening procedures, step 1900. For example, where each set of data is stored in a separate record as shown in FIG. 2 and background and credit checks are performed on each employment candidate for which a favorable initial hiring decision is received, OA System 300 may query AT Database 400 for each record 410: (a) whose set of data 411 matches certain criteria (e.g., application received at a particular office location); and (b) having values of “approved” in initial hiring decision field 412 and in the first screening procedure result field 413 and in the second screening procedure result field 413.

Next, OA System 300 may provide a report identifying each employment candidates found in the search, step 2000. For example, OA System 300 may cause each set of data found in the search to be printed in paper or electronic form, e.g., e-mail, and sent to a particular employment decision-maker at a particular office location of the organization.

Steps 1900 and 2000 may be performed continually and on a periodic basis, e.g., once a day or week, in order to inform specific office locations on a regular basis of all new hires for that location. For example, each day, OA System 300 may search AT Database 400 and provide reports of new hires (e.g., employment candidates who have received a favorable initial hiring decision and who have received favorable screening procedure results to each of the one or more screening procedures) to each location of the organization.

Any member of the organization with proper authorization may use a User Interface Device 100 to communicate with the Online Application System to obtain the application status of one or more employment candidates. For example, after providing authorization (e.g., user ID and password) the inquiring member may use an UI Device 100 to identify (e.g., by name or social security number) one or more employment candidates for which application status is desired. Alternatively, the inquiring member may request that application status be retrieved for one or more employment candidates matching certain search criteria (e.g., all employment candidates that filled in an online application at a particular office location). The OA System 300 receives this request and queries AT Database 400 for all the sets of data matching the request. The OA System 300 then presents to the inquiring member the initial hiring decision and one or more screening procedure results stored for each employment candidate from the request. It should be noted that where no initial hiring decision has been received or no screening procedures have been performed for an employment candidate, default values of “pending” may be stored for the initial hiring decision and one or more screening procedure results in association with the set of data identifying the candidate.

In addition, any member of the organization with proper authorization may access the OA System 300 to retrieve information and create reports. For example, after providing authorization (e.g., user ID and password) the member may use an UI Device 100 to request that certain information be extracted by OA System 300. For example, the member may provide a request for information for all employment candidates matching certain criteria (e.g., years of experience). The OA System 300 receives this request and queries AT Database 400 for all the sets of data matching the request. The OA System 300 may then create a report providing the information retrieved from AT Database 400 and transmit the report to the request member.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. A method for processing applications for employment, comprising:
receiving one or more sets of data, wherein each set of data identifies an employment candidate and represents an application for employment from the identified employment candidate;
storing each received set of data in a database;
receiving one or more initial hiring decisions, wherein each initial hiring decision corresponds to a set of data stored in the database; and
transmitting each set of data for which a favorable initial hiring decision is received to one or more screening officers to enable the one or more screening officers to cause one or more screening procedures to be performed on the employment candidate identified in the respective set of data, wherein each respective set of data is transmitted automatically upon receiving the corresponding favorable initial hiring decision.

2. The method of claim 1, further comprising:
storing each received initial hiring decision in the database in association with the set of data to which the respective received initial hiring decision corresponds;
receiving one or more screening procedure results from the one or more screening officers, wherein each of the one or more screening procedure results corresponds to a set of data stored in the database having a favorable initial hiring decision stored in association with it, and wherein each of the one or more screening procedure results corresponds to one of the one or more screening procedures; and
storing each of the received one or more screening procedure results in the database in association with the set of data to which the respective received screening procedure result corresponds.

3. The method of claim 2, further comprising:
receiving an identity for an employment candidate whose application status is to be determined;
searching the database for a set of data whose identified employment candidate matches the received identity; and
providing the screening procedure results stored in association with the matching set of data.

4. The method of claim 2, further comprising:
searching the database for each set of data wherein the initial hiring decision stored in association with the respective set of data is favorable, and wherein each screening procedure result stored in association with the respective set of data is favorable; and
informing the employment decision-maker of the identity of each employment candidate identified in each set of data found in the search.

5. The method of claim 4, wherein the steps of searching and providing are performed periodically.

6. The method of claim 2, further comprising:
providing a set of one or more interface screens to each employment candidate via a computer, wherein each set of one or more interface screens includes data input fields related to an application for employment; and
wherein the step of receiving one or more sets of data comprises receiving, through a network coupled to each computer, data from the data input fields of each set of one or more interface screens.

7. The method of claim 6, wherein the step of providing a set of one or more interface screens comprises providing a set of one or more interface screens including data input fields wherein at least some of the data input fields are mandatory such that data must be inputted to the mandatory fields before the step of receiving one or more sets of data is performed.

8. The method of claim 1, wherein the step of transmitting comprises sending an e-mail message including each set of data for which a favorable initial hiring decision is received to each of the one or more screening officers.

9. The method of claim 2, wherein the step of transmitting comprises transmitting each set of data for which a favorable initial hiring decision is received from the database to a one or more screening officers to enable the one or more screening officers to cause at least a background check and a credit check to be performed on the employment candidate identified in the respective set of data; and
wherein the step of receiving one or more screening procedure results from the one or more screening officers comprises receiving at least a background check result and a credit check result from the one or more screening officers.

10. The method of claim 2, further comprising:
extracting information from the database, wherein the extracted information includes one or more sets of data, the initial hiring decision stored in association with each extracted set of data, and the one or more screening procedure results stored in association with each extracted set of data; and
creating one or more reports based on the extracted information.

11. A system for processing applications for employment, comprising:
a plurality of user interface devices in communication with a network, wherein at least one of the user interface devices are operated by one or more employment candidates, wherein one of the user interface devices is operated by an employment decision-maker, and wherein at least one of the user interface devices is operated by one or more screening officers;
a database in communication with the network; and
a computer in communication with the network;
wherein the computer receives one or more sets of data from the user interface device operated by each of the one or more employment candidates, wherein each set of data identifies an employment candidate and represents an application for employment from the identified employment candidate;
wherein the computer stores each received set of data in the database;
wherein the computer receives one or more initial hiring decisions from the user interface device operated by the employment decision-maker, wherein each initial hiring decision corresponds to a set of data stored in the database; and
wherein the computer transmits each set of data for which a favorable initial hiring decision is received to each user interface device operated by each of the one or more screening officers to enable the one or more screening officers to cause one or more screening procedures to be performed on the employment candidate identified in the respective set of data, wherein each respective set of data is transmitted automatically upon receiving the corresponding favorable initial hiring decision.

12. The system of claim 11, wherein the computer stores each received initial hiring decision in the database in association with the set of data to which the respective received initial hiring decision corresponds;
wherein the computer receives one or more screening procedure results from the at least one user interface operated by the one or more screening officers, wherein each of the one or more screening procedure results corresponds to a set of data stored in the database having a favorable initial hiring decision stored in association with it, and wherein each of the one or more screening procedure results corresponds to one of the one or more screening procedures; and
wherein the computer stores each of the received one or more screening procedure results in the database in association with the set of data to which the respective received screening procedure result corresponds.

13. The system of claim 12, wherein the computer receives an identity of an employment candidate whose application status is to be determined from one of the user interface devices;
wherein the computer searches the database for a set of data whose identified employment candidate matches the received identity; and
wherein the computer provides the screening procedure results stored in association with the matching set of data to the user interface device that sent the identity of the employment candidate whose application status is to be determined.

14. The system of claim 12, wherein the computer searches the database for each set of data wherein the initial hiring decision stored in association with the respective set of data is favorable, and wherein each screening procedure result stored in association with the respective set of data is favorable; and
wherein the computer informs the employment decision-maker of the identity of each employment candidate identified in each set of data found in the search.

15. The system of claim 12, wherein the one or more screening procedures includes at least a background check and a credit check; and
wherein the one or more screening procedure results includes at least a background check result and a credit check result.

16. A system for processing applications for employment, comprising:
means for receiving one or more sets of data, wherein each set of data identifies an employment candidate and represents an application for employment from the identified employment candidate;
means for storing each received set of data in a database;
means for receiving one or more initial hiring decisions, wherein each initial hiring decision corresponds to a set of data stored in the database; and
means for transmitting each set of data for which a favorable initial hiring decision is received to one or more screening officers to enable the one or more screening officers to cause one or more screening procedures to be performed on the employment candidate identified in the respective set of data, wherein each respective set of data is transmitted automatically upon receiving the corresponding favorable initial hiring decision.

17. The system of claim 16, further comprising:
means for storing each received initial hiring decision in the database in association with the set of data to which the respective received initial hiring decision corresponds;
means for receiving one or more screening procedure results from the one or more screening officers, wherein each of the one or more screening procedure results corresponds to a set of data stored in the database having a favorable initial hiring decision stored in association with it, and wherein each of the one or more screening procedure results corresponds to one of the one or more screening procedures; and
means for storing each of the received one or more screening procedure results in the database in association with the set of data to which the respective received screening procedure result corresponds.

18. The system of claim 17, further comprising:
means for receiving an identity for an employment candidate whose application status is to be determined;
means for searching the database for a set of data whose identified employment candidate matches the received identity; and
means for providing the screening procedure results stored in association with the matching set of data.

19. The system of claim 17, further comprising:
means for searching the database for each set of data wherein the initial hiring decision stored in association with the respective set of data is favorable, and wherein each screening procedure result stored in association with the respective set of data is favorable; and
means for informing the employment decision-maker of the identity of each employment candidate identified in each set of data found in the search.

20. The system of claim 17, wherein the means for transmitting comprises means for transmitting each set of data for which a favorable initial hiring decision is received from the database to a one or more screening officers to enable the one or more screening officers to cause at least a background check and a credit check to be performed on the employment candidate identified in the respective set of data; and
wherein the means for receiving one or more screening procedure results from the one or more screening officers comprises means for receiving at least a background check result and a credit check result from the one or more screening officers.

21. A computer program product comprising a computer usable medium having computer readable code embodied therein, the computer readable code, when executed, causing a computer to implement a method for processing applications for employment, comprising:
receiving one or more sets of data, wherein each set of data identifies an employment candidate and represents an application for employment from the identified employment candidate;
storing each received set of data in a database;
receiving one or more initial hiring decisions, wherein each initial hiring decision corresponds to a set of data stored in the database; and
transmitting each set of data for which a favorable initial hiring decision is received to one or more screening officers to enable the one or more screening officers to cause one or more screening procedures to be performed on the employment candidate identified in the respective set of data, wherein each respective set of data is transmitted automatically upon receiving the corresponding favorable initial hiring decision.

22. The computer program product of claim 21, wherein the implemented method further comprises:
storing each received initial hiring decision in the database in association with the set of data to which the respective received initial hiring decision corresponds;
receiving one or more screening procedure results from the one or more screening officers, wherein each of the one or more screening procedure results corresponds to a set of data stored in the database having a favorable initial hiring decision stored in association with it, and wherein each of the one or more screening procedure results corresponds to one of the one or more screening procedures; and
storing each of the received one or more screening procedure results in the database in association with the set of data to which the respective received screening procedure result corresponds.

23. The computer program product of claim 22, wherein the implemented method further comprises:
receiving an identity for an employment candidate whose application status is to be determined;
searching the database for a set of data whose identified employment candidate matches the received identity; and
providing the screening procedure results stored in association with the matching set of data.

24. The computer program product of claim 22, wherein the implemented method further comprises:
searching the database for each set of data wherein the initial hiring decision stored in association with the respective set of data is favorable, and wherein each screening procedure result stored in association with the respective set of data is favorable; and
informing the employment decision-maker of the identity of each employment candidate identified in each set of data found in the search.

25. The computer program product of claim 22, wherein the step of transmitting comprises transmitting each set of data for which a favorable initial hiring decision is received from the database to a one or more screening officers to enable the one or more screening officers to cause at least a background check and a credit check to be performed on the employment candidate identified in the respective set of data; and
wherein the step of receiving one or more screening procedure results from the one or more screening officers comprises receiving at least a background check result and a credit check result from the one or more screening officers.
